(19) United States
(12) Patent Application Publication
(10) Pub. No.: US 2018/0294522 A1
(43) Pub. Date: Oct. 11, 2018

(54) HIGH-VOLTAGE LITHIUM-POLYMER BATTERIES FOR PORTABLE ELECTRONIC DEVICES

(71) Applicant: Apple Inc., Cupertino, CA (US)

(72) Inventors: Hongli Dai, Los Altos, CA (US); Richard Mank, Los Altos, CA (US)

(21) Appl. No.: 16/004,941

(22) Filed: Jun. 11, 2018

Related U.S. Application Data
(63) Continuation of application No. 13/408,693, filed on Feb. 29, 2012.
(60) Provisional application No. 61/551,324, filed on Oct. 25, 2011.

(51) Int. Cl. H01M 10/0565; H01M 10/0567; H01M 10/0525; H01M 4/131; H01M 4/1391

(52) U.S. Cl. CPC H01M 10/0565; H01M 10/0567; H01M 10/0525; H01M 4/1391; H01M 4/131; Y10T 29/49108

(57) ABSTRACT

The disclosed embodiments provide a lithium-polymer battery cell. The lithium-polymer battery cell includes an anode and a cathode containing lithium cobalt oxide particles doped with a doping agent. The lithium-polymer battery cell also includes a pouch enclosing the anode and the cathode, wherein the pouch is flexible. The cathode may allow a charge voltage of the lithium-polymer battery cell to be greater than 4.25V.

### RELATED APPLICATION

This application hereby claims priority under 35 U.S.C. § 119 to U.S. Provisional Application No. 61/551,324, entitled “High-Voltage Lithium-Polymer Batteries for Portable Electronic Devices,” by Hongli Dai, filed 25 Oct. 2011 (Atty. Docket No.: APL-P12705USP1).

### BACKGROUND

### Field

The present embodiments relate to batteries for portable electronic devices. More specifically, the present embodiments relate to the design and manufacture of high-voltage lithium-polymer batteries for portable electronic devices.

### Related Art

Rechargeable batteries are presently used to provide power to a wide variety of portable electronic devices, including laptop computers, tablet computers, mobile phones, personal digital assistants (PDAs), portable media players, and/or digital cameras. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

During operation, a lithium-polymer battery's capacity may diminish over time from an increase in internal impedance, electrode and/or electrolyte degradation, excessive heat, and/or abnormal use. For example, oxidation of electrolyte and/or degradation of cathode and anode material within a battery may be caused by repeated charge-discharge cycles and/or age, which in turn may cause a gradual reduction in the battery's capacity. As the battery continues to age and degrade, the capacity's rate of reduction may increase, particularly if the battery is continuously charged at a high charge voltage and/or operated at a high temperature.

Continued use of a lithium-polymer battery over time may also produce swelling in the battery's non-rigid cells and eventually cause the battery to exceed the designated maximum physical dimensions of the portable electronic device. Moreover, conventional battery-monitoring mechanisms may not include functionality to manage swelling of the battery. As a result, a user of the device may not be aware of the battery's swelling and/or degradation until the swelling results in physical damage to the device.

Hence, what is needed is a mechanism for minimizing swelling and improving capacity retention in high-voltage lithium-polymer batteries for portable electronic devices.

### SUMMARY

The disclosed embodiments provide a lithium-polymer battery cell. The lithium-polymer battery cell includes an anode and a cathode containing lithium cobalt oxide particles doped with a doping agent. The lithium-polymer battery cell also includes a pouch enclosing the anode and the cathode, wherein the pouch is flexible. The cathode may allow a charge voltage of the lithium-polymer battery cell to be greater than 4.25V.

In some embodiments, the doping agent includes an element or a compound of magnesium, titanium, zinc, silicon, aluminum, zirconium, vanadium, manganese, or niobium. The compound may correspond to an oxide, a phosphate, and/or a fluoride. The combined content of the doping agent and protection chemical in the cathode may be greater than 0.02% and less than 0.8% using a technique such as an inductively coupled plasma mass spectrometry (ICP-MS) technique.

In some embodiments, the lithium cobalt oxide particles have a median particle size (D50) of between 5 microns and 25 microns.

In some embodiments, the lithium cobalt oxide particles are further coated with a protection chemical.

In some embodiments, the protection chemical is about 200 nanometers thick. The protection chemical may also include an oxide, a phosphate, and a fluoride.

In some embodiments, the battery cell also includes an electrolyte containing electrolyte additives. The electrolyte additives may include ethylene carbonate, vinyl acetate, vinyl ethylene carbonate, thiophene, 1,3-propane sultone, succinic anhydride, and a dinitrile additive. The dinitrile additive may be malononitrile, succinonitrile, glutaronitrile, adiponitrile, and/or phthalonitrile.

In some embodiments, the content of the dinitrile additive is less than 5% by weight of the electrolyte.

In some embodiments, a water content in the cell is less than 200 parts per million (ppm), preferably less than 20 ppm.

In some embodiments, the pouch is less than 120 microns thick.

### BRIEF DESCRIPTION OF THE FIGURES

FIG. 1 shows a top-down view of a battery cell in accordance with the disclosed embodiments.

FIG. 2 shows a set of layers for a battery cell in accordance with the disclosed embodiments.

FIG. 3 shows a lithium cobalt oxide particle for a cathode of a battery cell in accordance with the disclosed embodiments.

FIG. 4 shows a flowchart illustrating the process of manufacturing a battery cell in accordance with the disclosed embodiments.

FIG. 5 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments relate to the design and manufacture of a lithium-polymer battery cell. The battery cell may contain a set of layers, including a cathode, a separator, and an anode. The layers may be wound to create a jelly roll and sealed into a flexible pouch to form the battery cell.

More specifically, the disclosed embodiments relate to the design and manufacture of a high-voltage lithium-polymer battery cell for portable electronic devices such as laptop computers, tablet computers, mobile phones, portable media players, and/or digital cameras. The high-voltage lithium-polymer battery cell may have a charge voltage of greater than 4.25V.

To prevent swelling and loss of capacity associated with the increased charge voltage, the cathode of the high-voltage lithium-polymer battery cell may include lithium cobalt oxide particles doped with a doping to stabilize the crystalline structure of the particles. The doping agent may include an element and/or compound of magnesium, titanium, zinc, silicon, aluminum, zirconium, vanadium, manganese, and/or niobium. The lithium cobalt oxide particles may also be coated with a protection chemical such as an oxide, a fluoride, and/or a phosphate. The combined content of the protection chemical and/or doping agent in the cathode may be between 0.02% and 0.8% using a technique such as an inductively coupled plasma mass spectrometry (ICP-MS) technique. The lithium cobalt oxide particles may have a median particle size (D50) of between 5 microns and 25 microns, and the coating of protection chemical may be about 200 nanometers thick.

To further offset swelling and/or degradation associated with a higher charge voltage, the electrolyte of the high-voltage lithium-polymer battery cell may contain electrolyte additives such as ethlylene carbonate, vinyl acetate, vinyl ethylene carbonate, thiophene, 1,3-propane sultone, succinic anhydride, and/or a dinitrile additive (e.g., malonitrile, succinonitrile, glutaronitrile, adiponitrile, phthalonitrile, etc.). The dinitrile content of the electrolyte may be less than 5% by weight of the electrolyte. Moreover, the water content in the cell may be less than 200 parts per million (ppm), preferably less than 20 ppm. The combination of cathode and electrolyte materials in the high-voltage lithium-polymer battery cell may reduce the rate of swelling and loss of capacity of the battery cell at the higher charge voltage, even if the battery cell is operated and/or stored at high temperatures.

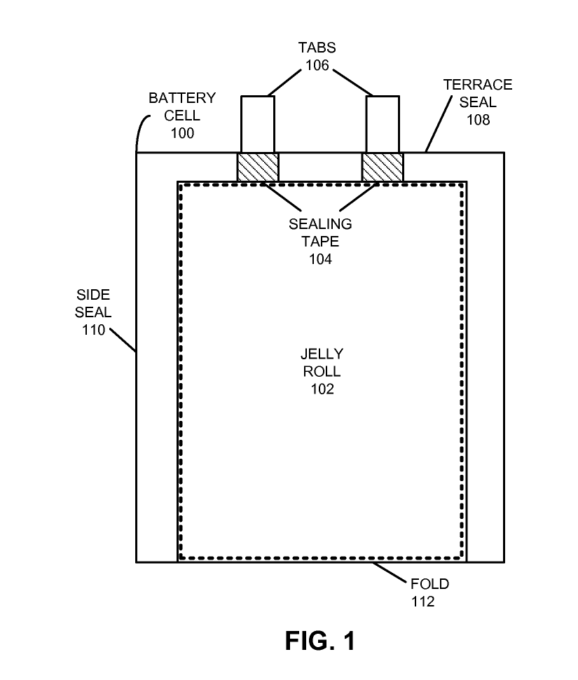

FIG. 1 shows a top-down view of a battery cell 100 in accordance with an embodiment. Battery cell 100 may correspond to a lithium-polymer battery cell that is used to power a portable electronic device. Battery cell 100 includes a jelly roll 102 containing a number of layers which are wound together, including a cathode with an active coating, a separator, and an anode with an active coating. More specifically, jelly roll 102 may include one strip of cathode material (e.g., aluminum foil coated with a lithium compound) and one strip of anode material (e.g., copper foil coated with carbon) separated by one strip of separator material (e.g., conducting polymer electrolyte). The cathode, anode, and separator layers may then be wound on a mandrel to form a spirally wound structure. Jelly rolls are well known in the art and will not be described further.

During assembly of battery cell 100, jelly roll 102 is enclosed in a flexible pouch, which is formed by folding a flexible sheet along a fold line 112. For example, the flexible sheet may be made of aluminum with a polymer film, such as polypropylene. After the flexible sheet is folded, the flexible sheet can be sealed, for example by applying heat along a side seal 110 and along a terrace seal 108. The flexible pouch may be less than 120 microns thick to improve the packaging efficiency and/or energy density of battery cell 100.

Jelly roll 102 also includes a set of conductive tabs 106 coupled to the cathode and the anode. Conductive tabs 106 may extend through seals in the pouch (for example, formed using sealing tape 104) to provide terminals for battery cell 100. Conductive tabs 106 may then be used to electrically couple battery cell 100 with one or more other battery cells to form a battery pack. For example, the battery pack may be formed by coupling the battery cells in a series, parallel, or series-and-parallel configuration. The coupled cells may be enclosed in a hard case to complete the battery pack, or the coupled cells may be embedded within the enclosure of a portable electronic device, such as a laptop computer, tablet computer, mobile phone, personal digital assistant (PDA), digital camera, and/or portable media player.

Those skilled in the art will appreciate that reductions in battery capacity may result from factors such as age, use, defects, heat, and/or damage. Furthermore, a decrease in battery capacity beyond a certain threshold (e.g., below 80% of initial capacity) may be accompanied by swelling of the battery that damages or distorts the portable electronic device.

In particular, charging and discharging of battery cell 100 may cause a reaction of electrolyte with cathode material, resulting in oxidation of the electrolyte and/or degradation of the cathode material. The reaction may both decrease the capacity of battery cell 100 and cause swelling through enlargement of the cathode and/or gas buildup inside battery cell 100. Moreover, the reaction may be accelerated if battery cell 100 is operated at higher temperatures and/or continuously charged at high charge voltages. For example, a lithium-polymer battery cell 100 that is operated at 25° Celsius and/or charged at 4.2V may reach 80% of initial capacity and increase in thickness by 8% after 1050 charge-discharge cycles. However, use of the same battery cell 100 at 45° Celsius and/or a charge voltage of 4.3V may decrease the capacity to 70% of initial capacity and increase the swelling to 10% after 1050 charge-discharge cycles.

In one or more embodiments, battery cell 100 corresponds to a high-voltage lithium-polymer battery cell with a charge voltage of greater than 4.25V. Furthermore, the cathode and separator (e.g., electrolyte) materials of battery cell 100 may be selected to minimize swelling and capacity loss in battery cell 100 at the higher charge voltage, and may further enable the operation and/or storage of battery cell 100 at high temperatures. The materials of battery cell 100 are discussed in further detail below.

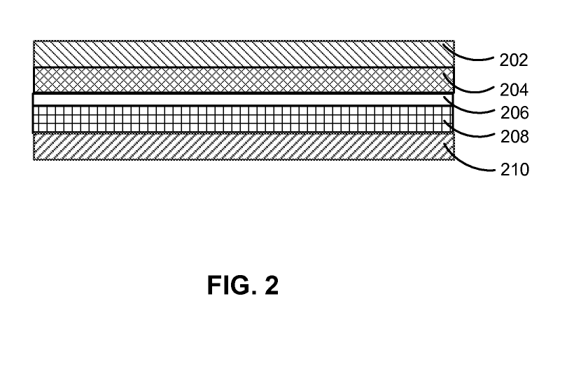

FIG. 2 shows a set of layers for a battery cell (e.g., battery cell 100 of FIG. 1) in accordance with the disclosed embodiments. The layers may include a cathode current collector 202, cathode active coating 204, separator 206, anode active coating 208, and anode current collector 210. Cathode current collector 202 and cathode active coating 204 may form a cathode for the battery cell, and anode current collector 210 and anode active coating 208 may form an anode for the battery cell. The layers may be wound to create a jelly roll for the battery cell, such as jelly roll 102 of FIG. 1.

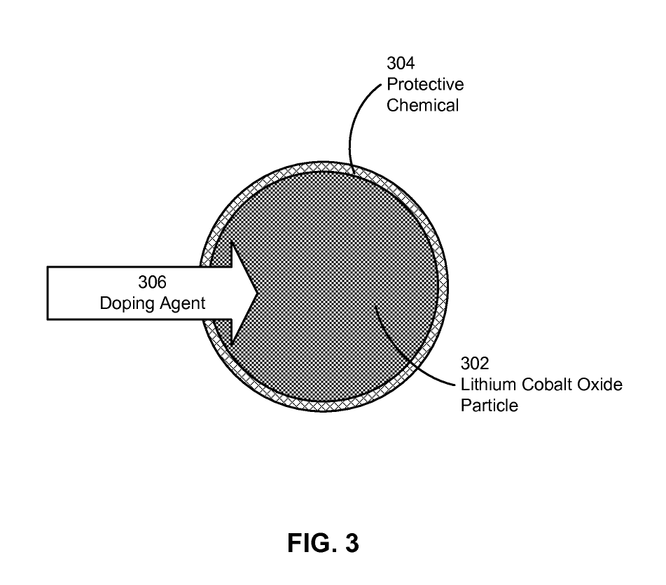

As mentioned above, cathode current collector 202 may be aluminum foil, cathode active coating 204 may be a lithium compound, anode current collector 210 may be copper foil, anode active coating 208 may be carbon, and separator 206 may include a conducting polymer electrolyte. More specifically, cathode active coating 204 may include lithium cobalt oxide particles coated with a protection chemical. The protection chemical may mitigate swelling and/or loss of capacity caused by the reaction of cathode active coating 204 with electrolyte in separator 206 during charging and/or discharging of the battery cell. The lithium cobalt oxide particles may additionally be doped with a doping agent. to stabilize the crystalline structure of the particles. The protection chemical and/or doping agent may include an element and/or compound of magnesium, titanium, zinc, silicon, aluminum, zirconium, vanadium, manganese, and/or niobium. The compound may correspond to an oxide, a fluoride, and/or a phosphate. Lithium cobalt oxide particles for use in cathodes of lithium-polymer battery cells are discussed in further detail below with respect to FIG. 3.

Electrolyte in separator 206 may contain electrolyte additives such as ethylene carbonate, vinyl acetate, vinyl ethylene carbonate, thiophene, 1,3-propane sultone, and/or succinic anhydride . To further offset degradation associated with charging and/or discharging of the battery cell, the electrolyte may also contain a dinitrile additive (e.g., malonitrile, succinonitrile, glutaronitrile, adiponitrile, phthalonitrile, etc.) that increases the temperature stability of the battery cell. For example, the inclusion of less than 5% by weight of a dinitrile additive in the electrolyte and less than 200 ppm of water (e.g., preferably less than 20 ppm) in the battery cell may keep swelling and/or capacity loss in the battery cell within acceptable bounds, even the battery cell is operated at high temperatures (e.g., 45° C.) and/or stored at high temperatures (e.g., 65°-85° C.).

The materials in the layers of the battery cell may thus allow the battery cell to be safely operated at a higher charge voltage than conventional lithium-polymer battery cells. For example, the combination of the coated and/or doped lithium cobalt oxide particles in the cathode, the dinitrile additive in the electrolyte, and/or the water content in the cell may keep swelling in the battery cell to less than 10% under storage conditions of 60° C. for 500 hours at 100% state-of-charge and/or 85° C. for six hours at 100% state-of-charge. The same battery cell may include more than 80% capacity retention and less than 10% swelling after 1000 charge-discharge cycles at 25° C.

FIG. 3 shows a lithium cobalt oxide particle 302 for a cathode of a battery cell in accordance with the disclosed embodiments. Lithium cobalt oxide particle 302 may have D50 of between 5 microns and 25 microns. As shown in FIG. 3, lithium cobalt oxide particle 302 may be doped with a doping agent 306. Doping agent 306 may stabilize the crystalline structure of lithium cobalt oxide particle 302 during charging and/or discharging of the battery cell.

Lithium cobalt oxide particle 302 may also be coated with a protection chemical 304 (e.g., using a solution phase reaction, solid state coating, mechanical grinding, etc.). Protection chemical 304 may be about 200 nanometers thick and reduce the rate at which lithium cobalt oxide particle 302 reacts with electrolyte during charging and/or discharging of the battery cell.

Doping agent 306 and/or protective chemical 304 may include the elements and/or compounds of magnesium, titanium, zinc, silicon, aluminum, zirconium, vanadium, manganese, and/or niobium. The compounds may correspond to oxides, metal fluorides, and/or metal phosphates. In addition, the combined content of doping agent 306 and protective chemical 304 in lithium cobalt oxide particle 302 may be greater than 0.02% but less than 0.8%, as measured by a measurement technique such as inductively coupled plasma mass spectrometry (ICP-MS).

The inclusion of protection chemical 304 and/or doping agent 306 in lithium cobalt oxide particle 302 may facilitate use of lithium cobalt oxide particle 302 in the cathode of a high-voltage lithium-polymer battery cell by offsetting the increased swelling and/or loss of capacity associated with a higher charge voltage for the battery cell. In addition, protection chemical 304 and/or doping agent 306 may not provide the same battery performance benefits with other types of cathode active material, such as lithium nickel cobalt manganese oxide and/or lithium nickel aluminum oxide. In other words, lithium cobalt oxide particles (e.g., lithium cobalt oxide particle 302) coated with protection chemicals (e.g., protection chemical 304) and/or doped with doping agents (e.g., doping agent 306) may be the only type of cathode active material that provides sufficient protection against swelling and/or cathode degradation associated with high charge voltages in lithium-polymer battery cells.

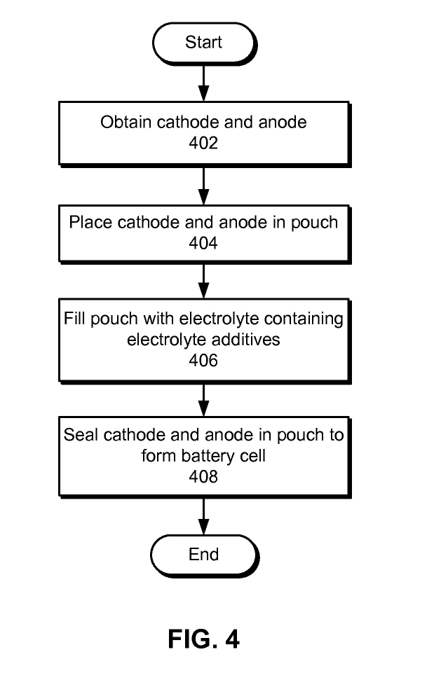

FIG. 4 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a cathode and anode are obtained (operation 402). The cathode may contain lithium cobalt oxide particles coated with a protection chemical and/or doped with a doping agent. The protection chemical and/or doping agent may include the elements and/or compounds of magnesium, titanium, zinc, silicon, aluminum, zirconium, vanadium, manganese, and/or niobium. The compounds may correspond to oxides, metal fluorides, and/or metal phosphates. Moreover, the combined content of the doping agent and protective chemical in the cathode may be greater than 0.02% but less than 0.8%. Next, the cathode and anode are placed into a pouch (operation 404). The pouch may include a layer of aluminum and a layer of either polypropylene or polyethylene. In addition, the pouch may have a thickness of less than 120 microns.

The pouch is then filled with electrolyte containing electrolyte additives (operation 406). The electrolyte additives may include ethylene carbonate, vinyl acetate, vinyl ethylene carbonate, thiophene, 1,3-propane sultone, succinic anhydride, and/or a dinitrile additive. The dinitrile additive may correspond to malononitrile, succinonitrile, glutaronitrile, adiponitrile, and phthalonitrile and make up less than 5% by weight of the electrolyte. In addition, the water content in the cell may be less than 200 ppm (e.g., preferably less than 20 ppm). Finally, the cathode and anode are sealed in the pouch to form the battery cell (operation 408). A charge voltage of greater than 4.25V may then be used with the battery cell to facilitate the powering of a portable electronic device from the battery cell.

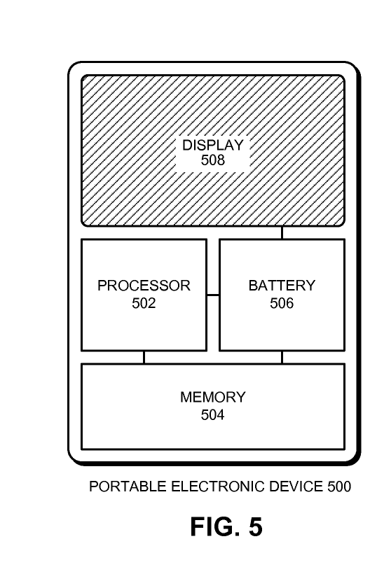

The above-described rechargeable battery cell can generally be used in any type of electronic device. For example, FIG. 5 illustrates a portable electronic device 500 which includes a processor 502, a memory 504 and a display 508, which are all powered by a battery 506. Portable electronic device 500 may correspond to a laptop computer, mobile phone, PDA, tablet computer, portable media player, digital camera, and/or other type of battery-powered electronic device. Battery 506 may correspond to a battery pack that includes one or more battery cells. Each battery cell may include an anode and a cathode sealed in a flexible pouch. The cathode may contain lithium cobalt oxide particles coated with a protection chemical and/or doped with a doping agent. The battery cell may also include an electrolyte containing electrolyte additives such as ethylene carbonate, vinyl acetate, vinyl ethylene carbonate, thiophene, 1,3-propane sultone, succinic anhydride, and/or a dinitrile additive. The dinitrile additive may include malononitrile, succinonitrile, glutaronitrile, adiponitrile, and phthalonitrile. In addition, the battery cell may contain less than 200 ppm of water.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A lithium-polymer battery cell, comprising:
an anode; and
a cathode comprising particles formed of LiCoO₂ doped with a doping agent and coated with a protection chemical;
wherein the doping agent comprises one or more of magnesium, titanium, zinc, silicon, aluminum, zirconium, vanadium, manganese, or niobium;
wherein the protection chemical comprises one or more of an oxide, a phosphate, or a fluoride; and
wherein a charge voltage of the lithium-polymer battery cell is greater than 4.25V.

2. The lithium-polymer battery cell of claim 1, wherein the doping agent comprises aluminum and manganese.

3. The lithium-polymer battery cell of claim 1, further comprising:
an electrolyte comprises an electrolyte additive, the electrolyte additive comprising one or more of ethylene carbonate, vinyl acetate, vinyl ethylene carbonate, thiophene, 1,3-propane sultone, succinic anhydride, or a dinitrile additive.

4. The lithium-polymer battery cell of claim 3, wherein the electrolyte additive comprises the dinitrile additive, the dinitrile additive comprising one or more of malononitrile, succinonitrile, glutaronitrile, adiponitrile, or phthalonitrile.

5. The lithium-polymer battery cell of claim 3, wherein the dinitrile additive is in a quantity less than 5% by weight of the electrolyte.

6. The lithium-polymer battery cell of claim 1, wherein a water content in the battery cell is less than 200 parts per million (ppm).

7. The lithium-polymer battery cell of claim 1, wherein the particles have a median particle size (D50) of between 5 microns and 25 microns.

8. A method for manufacturing a battery cell, comprising:
obtaining a cathode and an anode, wherein the cathode comprises lithium cobalt oxide particles doped with a doping agent and coated with a protection chemical; and
sealing the cathode and the anode in an enclosure to form the battery cell;
wherein the doping agent comprises one or more of magnesium, titanium, zinc, silicon, aluminum, zirconium, vanadium, manganese, or niobium; and
wherein the protection chemical comprises one or more of an oxide, a phosphate, or a fluoride.

9. The method of claim 8, wherein the doping agent comprises aluminum and manganese.

10. The method of claim 8, wherein the lithium cobalt oxide particles have a median particle size (D50) of between 5 microns and 25 microns.

11. The method of claim 8, wherein the protection chemical is about 200 nanometers thick.

12. The method of claim 8, further comprising:
filling the enclosure with an electrolyte comprising an electrolyte additive prior to sealing the cathode and the anode in the enclosure.

13. The method of claim 12, wherein the electrolyte additive comprises one or more of ethylene carbonate, vinyl acetate, vinyl ethylene carbonate, thiophene, 1,3-propane sultone, succinic anhydride, or a dinitrile additive.

14. The method of claim 8, wherein a water content in the battery cell is less than 200 parts per million (ppm).

15. A portable electronic device, comprising:
a set of components powered by a lithium-polymer battery cell with a charge voltage of greater than 4.25V, the battery cell comprising:
an anode; and
a cathode comprising particles formed of LiCoO₂ doped with a doping agent and coated with a protection chemical;
wherein the doping agent comprises one or more of magnesium, titanium, zinc, silicon, aluminum, zirconium, vanadium, manganese, or niobium; and
wherein the protection chemical comprises one or more of an oxide, a phosphate, or a fluoride.

16. The portable electronic device of claim 15, wherein the doping agent comprises aluminum and manganese.

17. The portable electronic device of claim 15, wherein the particles have a median particle size (D50) of between 5 microns and 25 microns.

18. The portable electronic device of claim 15, wherein the battery cell further comprises:
an electrolyte comprising an electrolyte additive, the electrolyte comprising one or more of an ethylene carbonate, vinyl acetate, vinyl ethylene carbonate, thiophene, 1,3-propane sultone, succinic anhydride, or a dinitrile additive;
wherein the dinitrile additive is at least one of malononitrile, succinonitrile, glutaronitrile, adiponitrile, and phthalonitrile.

19. The portable electronic device of claim 18, wherein a content of the dinitrile additive is less than 5% by weight of the electrolyte.

20. The portable electronic device of claim 15, wherein a water content in the battery cell is less than 200 parts per million (ppm).
